(19) United States
(12) Patent Application Publication
(10) Pub. No.: US 2005/0142298 A1
(43) Pub. Date: Jun. 30, 2005

(54) Method for fabricating nano pore

(76) Inventors: Jun Ho Kim, Kyungsangnam-Do (KR); Kang Ho Park, Daejeon-Shi (KR); Ki Bong Song, Daejeon-Shi (KR); Eun Kyoung Kim, Daejeon-Shi (KR); Sung Q. Lee, Daejeon-Shi (KR)

Correspondence Address: JACOBSON HOLMAN PLLC, 400 SEVENTH STREET N.W., SUITE 600, WASHINGTON, DC, 20004, US

(21) Appl. No.: 10/898,319

(22) Filed: Jul. 26, 2004

(30) Foreign Application Priority Data
Dec. 26, 2003 (KR) 2003-97064

(51) Int. Cl. B05D 3/00; B05D 7/00

(52) U.S. Cl. 427/532; 427/402; 427/355

(57) ABSTRACT

Provided is a method for fabricating a nanoscale pore which has been researched in a molecular electronics field of chemistry and in a molecular dynamics field of biology, wherein a oxidation pattern is selectively formed on a thin mask layer by anodic nano-oxidation using an AFM, and the oxidation pattern is selectively etched, thereby fabricating the nanoscale pore. Thus, the present invention provides a simple and easy method for fabricating nano pore array.

### BACKGROUND

1. Field of the Invention

The present invention generally relates to a method for fabricating a nanoscale pore which has been researched in a molecular electronics field of chemistry and in a molecular dynamics field of biology, and more particularly, to a method for fabricating a nano pore using an atomic force microscope (AFM).

2. Discussion of Related Art

A nanoscale structure has been researched to fabricate a nano electronic device or a single molecule spectroscopy of a biological field. However, the conventional nanoscale structure is fabricated by an electron-beam lithography process, a reactive ion etching (RIE) process, a micro-electromechanical system (MEMS) process, etc., so that its fabrication method is relatively complicated and requires relatively expensive equipment.

As a conventional method related to fabrication of the nano pore structure using the electron-beam lithography process or to nano patterning using nano oxidation, there are the following technologies.

The nano pore structure comprising silicon (Si) and silicon nitride (SiN) layers is fabricated by the electron-beam lithography process and Si-MEMS and then applied to a molecular electronic device [C, Zhou et al., “Nanoscale metal/self-assembled monolayer/metal heterostructures”, Appl. Phys. Lett. 71, 611, 1997].

A nano well array structure containing aluminum (Al) is fabricated on fused silica by the electron-beam lithography process and the RIE process, and DNA polymers activity is examined by a fluorescent microscope [M. J. Levene et. Al., “Zero-mode Waveguides for single-molecule analysis at high concentrations”, Science, 299, 682, 2003].

A silicon oxide (SiO) nano line pattern is fabricated by anodic nano-oxidation using an atomic force microscope (AFM) [E. S. Snow et al., “Fabrication of Si nanostructures with an atomic force microscope”, Appl. Phys. Lett. 64, 1932, 1994].

A titanium oxide (TiOₓ) nano-dots array is fabricated by the anodic nano-oxidation using the atomic force microscope (AFM) after depositing titanium (Ti) on a cover glass. Then, gold (Au) is deposited and a gold nano-dots array is fabricated in a corrugated form, and then its surface plasma effect is examined by a near-field scanning optical microscope (NSOM) [J. Kim et al., “Near-field imaging for surface plasmon on gold nano-dots fabricated by scanning probe lithography”, J. Microscopy. 209, 236, 2003].

As described above, the conventional methods for fabricating the nanoscale pore, using the electron-beam lithography process, the RIE process, the MEMS process, etc., are relatively complicated and require relatively expensive equipment. Further, the anodic nano-oxidation is applied to the fabrication of only the line pattern.

### SUMMARY OF THE INVENTION

The present invention is directed to a method for fabricating the nano pore, in which an oxidation pattern is selectively fabricated on a thin mask layer by anodic nano-oxidation using an AFM, so that the nano pore can be fabricated without relatively complicated processes and relatively expensive equipment.

One aspect of the present invention is to provide a method for fabricating a nano pore, comprising: forming a bottom layer and a thin mask layer on a plate in sequence; forming an oxidation pattern shaped like a pore locally on a predetermined portion of the thin mask layer contacting a cantilever tip by applying a bias voltage to the cantilever tip after placing the cantilever tip on the portion of the thin mask layer; and forming a pore on the thin mask layer by selectively removing the oxidation pattern.

According to an aspect of the invention, the bottom layer includes one of silicon dioxide (SiO₂), silicon (Si), platinum (Pt), titanium (Ti), chromium (Cr), aluminum (Al), gold (Au), silver (Ag), and indium tin oxide (ITO). Further, the thin mask layer includes one of silicon (Si), gallium arsenide (GaAs), titanium (Ti), zirconium (Zr), aluminum (Al), and chromium (Cr).

According to an aspect of the invention, the cantilever tip includes a cantilever tip of an atomic force microscope (AFM), and the cantilever tip is coated with one of tungsten carbide (W₂C), titanium (Ti), and platinum (Pt).

According to an aspect of the invention, the oxidation pattern is removed by a wet etching process using hydrogen fluoride (HF) or buffered oxide etchant (BOE) or a dry etching process using fluoric gas mixed with methane gas (CH₄) or hydrogen gas (H₂).

According to an aspect of the invention, the method further comprises cleaning the pore after forming the pore, wherein the cleaning is performed by a plasma etching process.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIGS. 1A through 1D are cross sectional views illustrating a process of fabricating a nano pore;

FIGS. 2A and 2B are partial perspective views illustrating the process of FIGS. 1C and 1D;

FIG. 3A is a plan view showing a nano pore array according to an embodiment of the present invention; and

FIG. 3B is a graph showing a profile of the nano pore array taken along the line A1-A2 of FIG. 3A.

### DETAILED DESCRIPTION OF PREFERRED EMBODIMENTS

Hereinafter, the exemplary embodiments of the present invention will now be described in more detail with reference to the accompanying drawings.

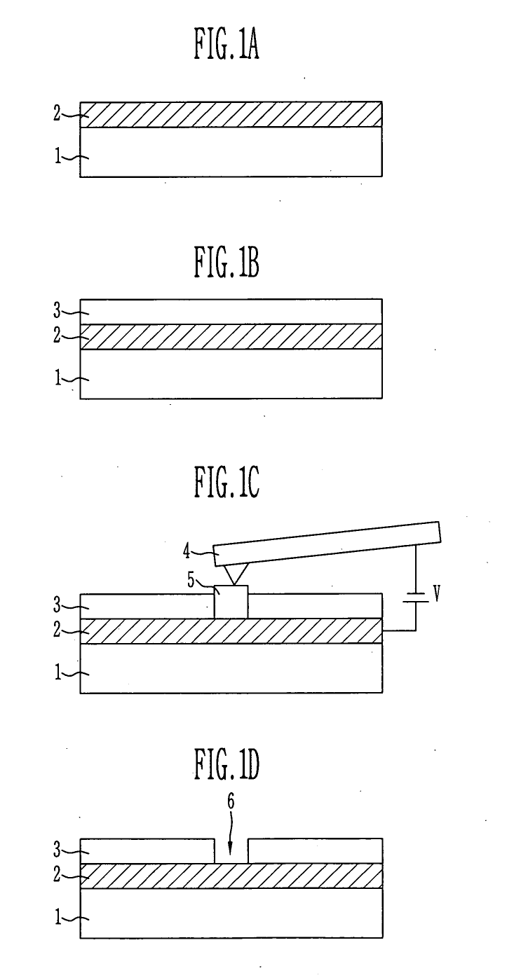

FIGS. 1A through 1D are cross sectional views for illustrating a process of fabricating a nano pore.

Referring to FIG. 1A, a bottom layer 2 is formed on a plate 1. Here, the bottom layer 2 is preferably made of silicon dioxide (SiO₂), silicon (Si), platinum (Pt), titanium (Ti), chromium (Cr), aluminum (Al), gold (Au), silver (Ag), indium tin oxide (ITO), etc., which are high etching selectivity relative to a thin mask layer to be formed on the bottom layer 2, are capable of forming a self-assembled monolayer, and are easy to adhere molecules thereto.

Referring to FIG. 1B, the thin mask layer 3 is formed on the bottom layer 2, having a thickness of 1 nm through 30 nm. Here, the thin mask layer 3 is preferably made of silicon (Si), gallium arsenide (GaAs), titanium (Ti), zirconium (Zr), aluminum (Al), chromium (Cr), etc., which can be oxidized.

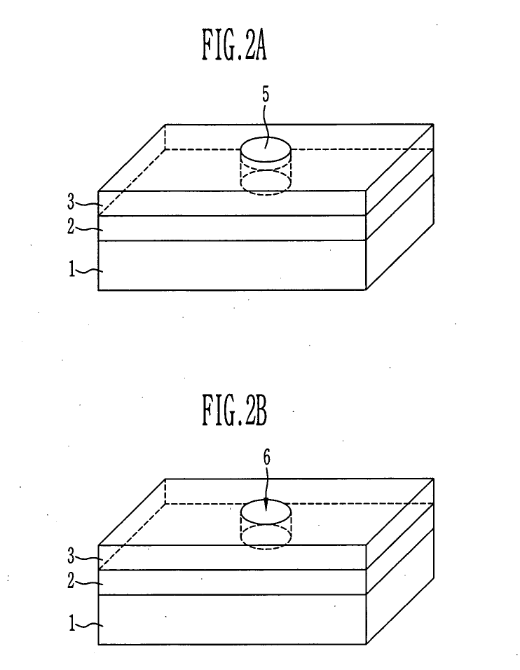

Referring to FIG. 1C, a cantilever tip 4 of an AFM is placed on a predetermined portion of the thin mask layer 3, that is, a portion in which a nano pore will be formed. Thereafter, a bias voltage V is applied between the cantilever tip 4 and the plate 1 or between the cantilever tip 4 and the bottom layer 2, so that a nanoscale oxidation pattern 5 is locally formed at the portion of the thin mask layer 3 contacting the cantilever tip 4. That is, when the bias voltage V is applied to the cantilever tip 4, the thin mask layer 3 is oxidized by a chemical reaction of an oxygen ion near the cantilever tip 4. At this time, as shown in FIG. 2A, the volume of the oxidation pattern 5 is a little expanded according as the thin mask layer 3 is oxidized.

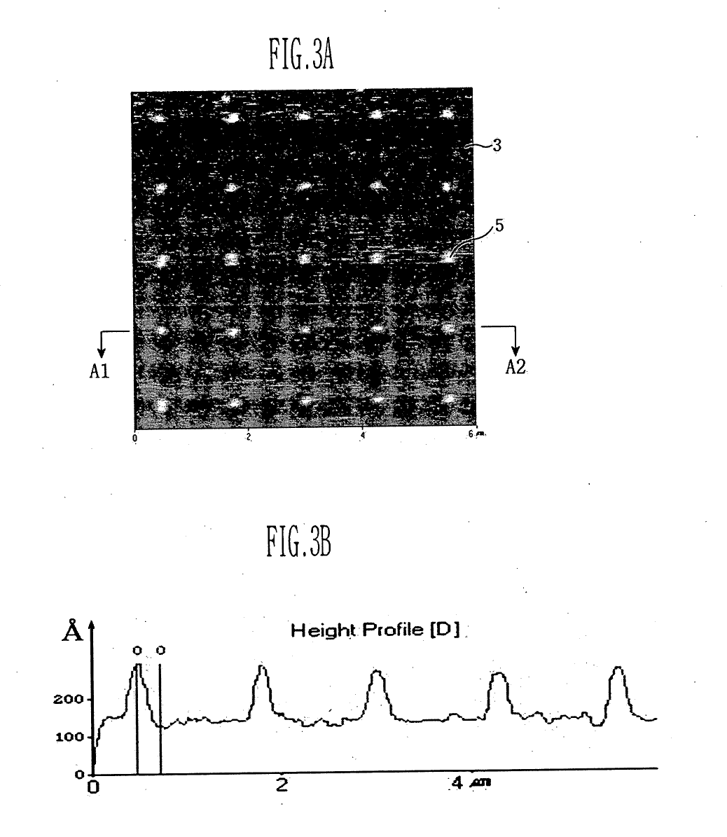

Such oxidation pattern 5 can be arrayed as shown in FIG. 3A. In this case, a profile of the nano pore array is shown in FIG. 3B.

Referring to FIG. 1D, the oxidation pattern 5 is selectively removed by a wet etching process using hydrogen fluoride (HF), buffered oxide etchant (BOE), etc. or a dry etching process using fluoric gas such as perfluoromethane (CF₄), perfluoroethane (C2F₆), trifluoromethane (CHF₃), etc. mixed with methane gas (CH₄) or hydrogen gas (H₂) to have higher etching selectivity relative to the oxide layer, thereby forming a nanoscale pore 6 on the thin metal layer 3. In the etching process, concentration or temperature of the etchant is preferably adjusted to appropriately optimize an etching condition.

After the nano pore 6 is formed, a cleaning process can be performed by an etching process using plasma such as argon (Ar). FIG. 2B illustrates the nano pore 6 formed by etching the oxidation pattern 5.

According to an embodiment of the present invention, pulsed laser deposition, sputtering, chemical vapor deposition, electron-beam evaporation, thermal evaporation, etc. can be employed for forming the bottom layer 2 or the thin mask layer 3.

Further, the cantilever tip 4 of the AFM is preferably made of a tip coated with metal such as tungsten carbide (W₂C), titanium (Ti), platinum (Pt), etc. or other conductive tips. To smooth the foregoing oxidation, the bias voltage can be increased or humidity can be locally increased.

As described above, according to the present invention, the oxidation pattern is selectively formed on the thin mask layer by the anodic nano-oxidation using the AFM, thereby fabricating the nanoscale pore. Thus, the nano pore structure or the nano pore array is easily fabricated without a relatively complicated process and relatively expensive equipment, which can be effectively applied to optical researches for a molecular electronic device or a single molecule spectroscopy of a biological field.

While the present invention has been described with reference to a particular embodiment, it is understood that the disclosure has been made for purpose of illustrating the invention by way of examples and is not limited to limit the scope of the invention. And one skilled in the art can make amend and change the present invention without departing from the scope and spirit of the invention.

1. A method for fabricating a nano pore, comprising the steps of:
forming a bottom layer, and a thin mask layer on a plate in sequence;
forming an oxidation pattern shaped like a pore locally on a predetermined portion of the thin mask layer contacting a cantilever tip by applying a bias voltage to the cantilever tip after placing the cantilever tip on the portion of the thin mask layer; and
forming a pore on the thin mask layer by selectively removing the oxidation pattern.

2. The method as claimed in claim 1, wherein the bottom layer includes one of silicon dioxide (SiO₂), silicon (Si), platinum (Pt), titanium (Ti), chromium (Cr), aluminum (Al), gold (Au), silver (Ag), and indium tin oxide (ITO).

3. The method as claimed in claim 1, wherein the thin mask layer includes one of silicon (Si), gallium arsenide (GaAs), titanium (Ti), zirconium (Zr), aluminum (Al), and chromium (Cr).

4. The method as claimed in claim 1, wherein the cantilever tip includes a cantilever tip of an atomic force microscope (AFM).

5. The method as claimed in claim 1, wherein the cantilever tip is coated by one of tungsten carbide (W₂C), titanium (Ti), and platinum (Pt).

6. The method as claimed in claim 1, wherein the oxidation pattern is removed by a wet etching process using any one of hydrogen fluoride (HF) and buffered oxide etchant (BOE).

7. The method as claimed in claim 1, wherein the oxidation pattern is removed by a dry etching process using any one of fluoric gas mixed with methane gas (CH₄) and hydrogen gas (H₂).

8. The method as claimed in claim 1, further comprising cleaning the pore after forming the pore.

9. The method as claimed in claim 8, wherein the cleaning is performed by a plasma etching process.
